(19) United States
(12) Patent Application Publication
(10) Pub. No.: US 2003/0065949 A1
(43) Pub. Date: Apr. 3, 2003

(54) International trade system

(76) Inventors: Madeleine Le, Los Altos, CA (US); Peggy Milovina-Meyer, Cupertino, CA (US); Michael B. Williams, San Jose, CA (US); Patrick M. Dailey, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/969,368

(22) Filed: Oct. 1, 2001

(51) Int. Cl. G06F 12/14

(52) U.S. Cl. 713/201; 709/229

(57) ABSTRACT

An international trade information system (“ITIS”) for managing the transfer of purchased goods across international borders, including regulatory and tax considerations. The ITIS works with a plurality of internal and external service engines that are inside and outside the protection of a software firewall, respectively. The various service engines are configured to provide various international trade e-services appropriate to various jurisdictions, but are not configured to be used in a completely integrated system. The ITIS includes an application server module configured to guide a user through the operation of the service engines as needed to complete the service needs of the user. The application server module buffers the user's interactions with the service engines for an integrated and consistent interface, and integrates the interaction of the service engines to form a seamless, fully integrated system. The ITIS also includes a firewall-spanning message broker configured to provide for direct service engine to service engine communication, and to bring users' information systems into the integrated network to further develop integrated operation.

The present invention relates generally to international trade, and more particularly, to systems, software and related business methods for handling the international trade.

### BACKGROUND OF THE INVENTION

International business transactions frequently lead to issues in the international transportation of goods. The transactions can take place between related or unrelated business entities, any of whom could be barred from international trade by certain countries or with their citizens and corporations. The goods can be finished products for the consumer market or components for use in manufacture. They likewise can be environmentally sensitive or toxic goods, goods restricted for security reasons, and/or goods packaged in ways that must be reported in certain countries. The goods can be subject to export license requirements, import duties, and customs regulations. These issues can arise with each international border crossed by the goods, even goods that are simply in transit through a jurisdiction.

A typical commercial shipment could involve nine different participants, 20 separate documents, 35 customer-vendor interactions and four modes of transport. It could require weeks or months to complete, and can cross several international borders. Thus, an elaborate supply chain including manufacturers, distributors, retailers and transportation service providers including freight forwarders, carriers and customs brokers has developed around the world. The resulting global transportation industry is one of the largest and most complex in the world, requiring a high level of expertise in a variety of transportation issues that vary from legal jurisdiction to jurisdiction.

In this complex marketplace of services, buyers and sellers are frequently inexperienced, lacking knowledge of the wide variety of legal requirements placed on international transportation by each country. As a result, a large corporation with thousands of buyers and sellers world wide can have extreme variation in its practices. This potentially leads to noncompliance or inconsistent compliance with various national laws, excessive delivery times, additional expenses in customs, shipping and brokering, and unclaimed drawbacks from refundable duties. Furthermore, because transportation procedures are not consistently maintained, little quality control can be exercised in monitoring preferred procedures and selecting better-performing service providers. A noncompliance with national laws is particularly important, as it can lead to both extreme financial penalties and the arrest and incarceration of people ignorantly conducting transactions violating the law.

Presently, interaction between importers, exporters and their service providers is primarily conducted via paper, phone and facsimile. The industry lacks industry-based universal formats and standards, and customers use different sets of processes with each service provider. Information from global logistics typically remains disconnected from enterprise systems designed to drive efficiencies across global supply chains.

In attempting to automate and standardize processes, numerous transportation service providers have developed automated processes within their areas of expertise. Such efforts have produced tax services, shipment tracking services, customs invoicing services, duty calculation services, customs classification services, import regulation services, export regulation services, and a large host of other applications. For a customer to take advantage of each such application, that customer (e.g., buyer, seller or related service provider) must know to use the application, purchase access to the application, learn to use the application, and provide all relevant information for the application to use. Additionally, because these solutions can be regional in applicability, and because these solutions can be inferior for some types of transactions or locations, while superior for others, their consistent use by a user familiar with just the one application can be limited in effectiveness by its inferiority when used for other jurisdictions.

In some cases, providers are bundling these point solutions into packages of related software. For example, there are bundles of software configured for tax calculation, bundles of software for landed cost calculation, bundles of software configured for export issues and bundles of software configured for import issues.

These bundles combine specific point solutions, and therefore adopt their limitations and weaknesses. They each commonly operate without consideration of factors from numerous other substantive or jurisdictional areas. For example, packages for estimating costs cannot typically consider the incremental costs incurred in export (e.g., license requirements and restricted party limitations), import (e.g., duties and environmental limitations), logistics (e.g., shipping costs that vary based on a particular customer's pricing agreements), taxes (e.g., customer preferences for claiming “assists” and other tax related activities) and other such issues. Furthermore, even presuming that all customers could be trained and educated on the use of each such bundle, separate business arrangements and technology connections need to be established and maintained for each bundle, adding to the overall cost of conducting international transportation of goods.

Accordingly, there has existed a need for an improved system for international trade and the conduct of international business transactions. Such a system would preferably provide for improved speed, accuracy, legality and consistency. Preferred embodiments of the present invention satisfy these and other needs, and provide further related advantages.

### SUMMARY OF THE INVENTION

In various embodiments, the present invention solves some or all of the needs mentioned above, providing systems, software and related business methods for handling the international transportation of goods.

The invention, in many embodiments, is a system configured to operate with both a plurality of internal service engines that operate within the protection of a software firewall, and a plurality of external service engines that operate outside the firewall. The internal and external service engines are configured to provide a variety of separate services that are not fully integrated. The invention features an application server module, being configured to selectively send data to, receive data from, and/or share data between the service engines. The application server module uses this data passing and sharing to selectively operate the service engines and integrate their separate services into an integrated service. Any number of users having needed of the integrated service can request the integrated service by accessing the application server module via an interface module.

This feature advantageously provides for efficiently meeting users service needs with reduced costs and better results. In particular, by offering the service as an integrated service, the system can avoid significant training of each user, both in learning all requirements to fulfill the service needs, and in learning how to separately operate each service engine. Integration also provides for both a seamless single point of entry, a consistent user interface and intelligently guided operation. Furthermore, by integrating the applications, there is a significant savings in user time, as the human portion of the task is reduced in scope. Additionally, by having an intelligent interface that requires all users to deal with every aspect of the service needs, more consistent performance is achieved throughout a large company of users, and in cases where legal requirements exist, an improved level of legal compliance by the corporation as a whole can be achieved.

By integrating operations that have a bearing on each other, the features of the invention also advantageously provide for better record-keeping, and therefore superior accountability is achieved. This leads to lower relationship costs and more accurate reporting and compliance with laws and objectives. The centralized interconnection of the service engines also provides for efficient maintenance and simple oversight. Furthermore, modernization and upgrades can be accomplished with minimum effort by swapping service engines, leading to better negotiating power with outside providers of service engines.

The invention further features a service engine communication layer connecting the application server to each service engine. The service engine communication layer is configured to translate communication protocols to facilitate communication between the application server module and service engines that use any of a variety of communication protocols. This feature provides for the use of service engines from a variety of sources without having to purchase reprogramming services from the sources. Furthermore, because the service engine communication layer will typically have an extensive selection of communication protocols, many new service engines can be integrated without any significant investment of time or effort, giving a plug-and-play capability to service engines that are not designed to have it.

Embodiments of the invention can also feature a router configured to place the service engine communication layer in communication with each external service engine via a single hole in the firewall. This feature advantageously allows for improved security, while also minimizing necessary programming efforts to integrate new service engines.

A combined message broker is also featured in the invention. The combined message broker includes an internal within the firewall and an external message broker outside the firewall. The internal and external message brokers are linked in communication with each other through the firewall. For each interacting service engines, which is a service engines configured to interact with other interacting service engines, the combined message broker is configured to provide a communications link between the interacting service engines, and with internal and external reference servers. In particular, the internal and external message brokers are configured to communicate with the internal and external components (i.e., service engines and reference servers), respectively. Preferably, the combined message broker is configured to translate communication protocols to facilitate the interaction between the interacting service engines that use different communication protocols.

Advantageously, these features provide for data communication capabilities to interlink the service engines, just as the service engine communication layer provides interactive communication capabilities to interlink the service engines. Thus, these features also aid in providing the advantages of the application server and communication layer, such as reduced costs in training, operations, efficiency, maintenance, and modernization. They also provide performance improvements, end-to-end transaction visibility, and enable compliance with rules and laws, thereby reducing noncompliance issues.

Other features and advantages of the invention will become apparent from the following detailed description of the preferred embodiments, taken with the accompanying drawings, which illustrate, by way of example, the principles of the invention. The detailed description of particular preferred embodiments, as set out below to enable one to build and use an embodiment of the invention, are not intended to limit the enumerated claims, but rather, they are intended to serve as particular examples of the claimed invention.

### BRIEF DESCRIPTION OF THE DRAWINGS

FIG. 1 is a block diagram of a TLCL system architecture embodying the invention.

### DETAILED DESCRIPTION OF THE PREFERRED EMBODIMENTS

The invention summarized above and defined by the enumerated claims may be better understood by referring to the following detailed description, which should be read with the accompanying drawings. This detailed description of particular preferred embodiments of the invention, set out below to enable one to build and use particular implementations of the invention, is not intended to limit the enumerated claims, but rather, it is intended to provide particular examples of them.

Typical embodiments of the present invention reside in a computer system, and related software and business methods, configured for handling international trade. A first preferred embodiment of the invention is configured for handling business tax, license (export administration), customs and/or logistics (TLCL) issues in the import/export of goods across international borders. This preferred embodiment of the invention resides in a system to link and direct certain electronic communication between buyers, sellers, customs brokers, shippers, other service providers, with information and services from various computer software service engines, which can be operated and maintained by a variety of entities, that are not designed to be integrated with each other. Additionally, preferred embodiments of the invention reside in the computer system and related software and business methods recited above, when combined with the service engines to form a networked system for guiding a user through the TLCL issues raised by a business transaction spanning one or more international borders.

Typically, embodiments of this invention integrate a full range of TLCL applications, providing distinct business functions, into a single seamless set of services. This integration provides synergies that are not typically available to inexperienced customers. Because the technology includes intelligence in the front end, users can operate the software without having expertise in TLCL issues. This allows a corporation to operate import/export operations legally, efficiently, cost-effectively, and consistently, while allowing individual business people to conduct their own transactions (i.e., without surrendering complete control to a centralized department disconnected from the needs and business practices of the individual customers).

Customers

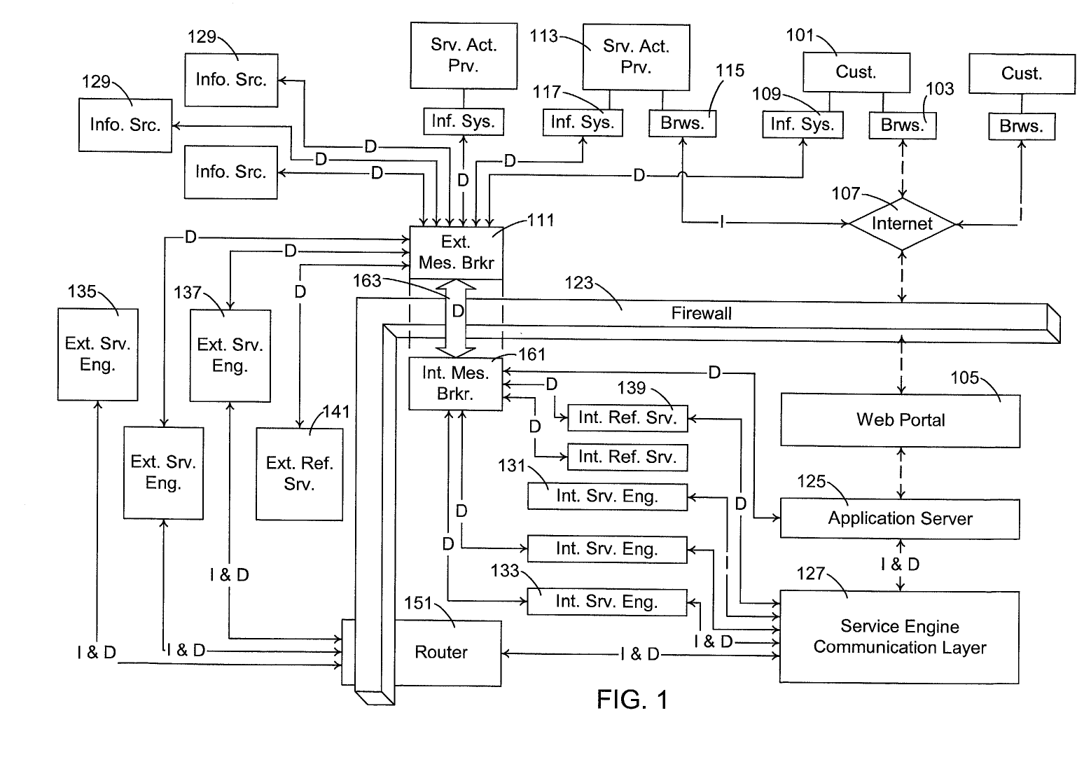

With reference to FIG. 1, the TLCL system is configured to assist and guide both buyers and sellers, which will jointly be referred to as Customers 101, through the range of TLCL issues that they face in cross-border transactions. To be a user of the TLCL system, the Customers will typically access a local computer having a browser 103. That Customer and their computer are placed in interactive communication with the TLCL system, preferably through a user interface such as a web portal 105, via a data communications network such as the Internet 107. These communications channels (denoted as interactive by an “I” in FIG. 1) are used for interactive communication between a customer and the TLCL system.

Customers 101 also might possess other computers placed in communication with the TLCL system. In particular, Customers may have local information systems 109 that communicate with the TLCL system, either via a communications network such as the Internet using various standard communications protocols, or via direct communication lines established with the TLCL system. These communications channels (denoted as being for data transfer by a “D” in FIG. 1) are used for low level, computer to computer data transfer that does not involve a Customer interactively participating in the transfer. These interactions can be request-and-reply-type communications or data objects (i.e., messages communicating events). The customer-based information systems might conduct many different functions relating to ordering, accounting, and various TLCL issues. Preferably the customer-based information systems will directly communicate with a computer system serving as an external message broker 111 for the TLCL system.

Large corporate clients of the TLCL system can contain many individual TLCL-system Customers 101 spread across many countries. For example, within an international conglomerate, there can be many thousands of purchasers and sellers that operate separately and distinctly from each other, each having their own information systems 109 and their own purchasing and selling procedures.

In addition to the above facilities, Customers 101 will likely have facsimile machines and other communications devices that provide for information sharing. Because there is a myriad of possible Customers, there will be a wide variety of different communication capabilities among the Customers, even within the same corporate client of the TLCL system. Some Customers might not have information systems configured to interact with the TLCL system, some might not have browsers, and some might have little to work with other than a telephone. Customers 101 will have varying levels of knowledge about the myriad of TLCL requirements that international transactions must meet. Some Customers will have significant experience with transactions across many regions of the world, and will be at least somewhat familiar with many countries' TLCL requirements. Other Customers will have experience within a certain region, such as the countries of the European Union, but will have little knowledge of the TLCL requirements of countries outside their region of expertise. Finally, some Customers will have little to no experience with TLCL issues at all.

Service Activity Providers

The import/export industry includes a large number of providers of service activities to assist buyers and/or sellers in conducting international trade. These providers, which shall be referred to as Service Activity Providers 113, include customs brokers, forwarders, carriers, and free-trade zone managers. For example, in countries where it is legal, customs brokers typically act as the buyer's agent (or possibly the seller's agent) with the local customs service. Carriers physically transport the goods, via plane, truck, train, boat or otherwise, and forwarders coordinate carriers for complex shipping needs. Free-trade zone managers operate free-trade zones in countries such as the United States, where they are legal.

Like the Customers 101, the Service Activity Providers 113 will interact with the TLCL system as users, preferably using interactive and data communications means (denoted by an “I” and “D”, respectively, in FIG. 1). For an interactive communication means, the Service Activity Providers can use a local computer having a browser 115. That computer is placed in interactive communication with the TLCL system, preferably through the web portal 105, via a data communications network such as the Internet 107.

For a data communication means, Service Activity Providers 113 are likely to use computers that assist in conducting their business activities, such as for generating documents, tracking shipments, scheduling activities, and the like. These computers are placed in communication with the TLCL system to communicate relevant data. In particular, Service Activity Providers may have local information systems 117 that communicate with the TLCL system via a means of communicating data, such as direct communication lines established with the TLCL system or a communications network like the Internet. Preferably the local information systems will communicate with the external message broker 111 for the TLCL system.

Similar to the Customers 101, the Service Activity Providers 113 will likely have facsimile machines and other non-interactive communications devices that provide for information sharing. Because there are a large number of Service Activity Providers, there are a wide variety of different communication capabilities among the Service Activity Providers. Some might not have information systems 117 configured to interact with the TLCL system, some might not have browsers 115, and in some portions of the world, some might be very isolated (e.g., a local transportation company in a remote third world location might be very limited in communication facilities).

Service Activity Providers 113 will often be expert in their field and/or their local market. However, they will not often be well acquainted with the Customers' goods and the legal concerns raised by those goods.

TLCL System

The TLCL system is generally under the control and/or direction of a TLCL System Provider that owns and operates the TLCL system. The TLCL System Provider can be an entity that requires the TLCL services for its own purposes, such as an international conglomerate that has large numbers of buyers and/or sellers conducting international business transactions. Alternatively, the TLCL System Provider can be an entity who's primary business is the provision of services to companies that requires the TLCL services. Of course the TLCL System Provider potentially can fill both of the above-mentioned roles. Preferably, the TLCL System Provider can access the TLCL system both via access to the TLCL system computers, and indirectly via a browser in the same manner as a Customer 101 or Service Activity Provider 113.

Typical embodiments of the TLCL system will include a network of computer hardware and software, characterized by an architecture defining a firewall 123, the web portal 105, and an application management system including an application server 125, which could also be referred to as a process server, and a service engine communication layer 127. A variety of TLCL services are integrated and provided through the use of a plurality of service engines. Included among these are one or more internal service engines that are within the firewall, and one or more external service engines outside the firewall. Some data used by the service engines, such as government regulations, classifications and restricted parties, are kept up-to-date via data communications with information sources 129.

Strictly interactive internal service engines 131 are configured for only interactive, real-time processing of TLCL issues for Customers 101 or Service Activity Providers 113, while mixed interactive internal service engines 133 are configured for both interactive processing and data-type processing in response to the receipt of requests and/or data objects representing various relevant queries and/or events. Likewise, strictly interactive external service engines 135 are configured for only interactive, real-time processing of TLCL issues for Customers 101 or Service Activity Providers 113, while mixed interactive external service engines 137 are configured for both interactive processing and data-type processing in response to the receipt of requests and/or data objects representing various relevant queries and/or events. Internal or external devices that only conduct data-type processing in response to the receipt of requests representing various relevant queries are referred to as internal reference servers 139 and external reference servers 141, respectively. However, while these devices typically serve in a database capacity, they might conduct some processing to meet the requirements of some queries.

Interactive Processing Communications

Each service engine configured for interactive processing is in interactive communication with the service engine communication layer 127 of the application management system via an interactive connection (denoted as interactive by an “I” in FIG. 1). The service engine communication layer provides translation facilities for communication with the wide variety of communication protocols that might be used by the service engines.

In particular, each internal service engine 131 and 133 is linked to the service engine communication layer 127 via an internal interactive connection (denoted as interactive by an “I” in FIG. 1) configured for communicating interactive information. Each external service engine 135 and 137 is preferably linked to a router 151 via an external interactive connection (denoted as interactive by an “I” in FIG. 1) configured for communicating interactive information. The router has an interactive communications link (denoted as interactive by an “I” in FIG. 1) placing it in communication with the service engine communication layer. The router preferably spans the firewall 123, providing for a single “hole” in the firewall to support all interactive communications between the service engine communication layer and all or most of the external service engines. Optionally, some external service engines could be in communication with the service engine communication layer through separate holes in the firewall that are not maintained by the service engine communication layer and the router. The service engine communication layer can be considered a layer of the application server rather than a separate module.

Within the application management system, the service engine communication layer 127 is linked in communication with the application server 125, which directs, buffers and processes the various communications between the users and the service engines 131, 133, 135 and 137. The application management system communicates with the users via the web portal 105.

The firewall, 123, the web portal 105 and the application server 125 each provide authentication and security tasks for verification of the users' interactive usage rights in the TLCL system. In particular, the firewall includes a web agent that limits web portal access to verified users, thus serving as a gatekeeper to the web portal. The web portal 105 also includes a web agent that limits the general types of tasks that each user is allowed to conduct. Finally, the application server, which governs the operation of the service engines, limits access to the particular sub-functions and information for which the user has approved access.

For example, when a customs broker accesses the TLCL system using its browser 115, the firewall web agent verifies that the customs broker is within the group of approved users, and then allows the customs broker access to the web portal. At the web portal, the customs broker is provided a set of TLCL operations to which the customs broker has access. The extent of that set of options is governed by the web agent of the web portal 105. After the customs broker selects a function, such as customs invoice generation, the application server 125 leads the customs broker through a series of interactions with a series of service engines. The application server web agent controls the customs broker's access to the individual functions within each service engine, based on the customs broker's approved access. The application server web agent further controls the customs broker's access, limiting it to data that the customs broker is allowed to access. Thus, security and authentication over interactive communications are conducted in three levels.

Data-Type Communications

Each service engine configured for data-type processing is interconnected via connections configured for communicating requests and replies (e.g., database queries and related processing), and/or data objects. These data connections are denoted as being for data transfer by a “D” in FIG. 1. Depending on the type of data transfer, data-type communications are conducted either via a gate-keeping message broker or the service engine communication layer 127.

The gate-keeping message broker includes an internal message broker 161 and the external message broker 111. These two portions of the gate-keeping message broker are linked via a data-type communications link 163 passing through a hole in the firewall 123. The internal message broker is in data-type communication with both the internal reference servers 139 and the internal service engines 133 configured for data processing in response to the receipt of requests and/or data objects representing various relevant queries and/or events. Likewise, the external message broker 111 is in data-type communication with both the external reference servers 141 and the external service engines 137 configured for data processing in response to the receipt of requests and/or data objects representing various relevant queries and/or events. Through the gate-keeping message broker, these entities can be kept in data-type communications. Optionally, some external service engines could be in communication with the internal message broker or with internal service engines through separate holes in the firewall that are not managed by the router.

To direct particular queries to which a service engine requires a reply, such a query is sent by the requesting service engine to the portion of the gate-keeping message broker on the same side of the firewall as the requesting service engine. The gate-keeping message broker then directs the query to the appropriate, replying service engine or reference server to reply to the request. If the replying service engine or reference server is on the opposite side of the firewall from the requesting service engine, then the request is appropriately passed between the internal and external broker portions of the gate-keeping message broker. Similarly, when the reply is generated by the replying service engine or reference server, it is sent to the portion of the gate-keeping message broker on the same side of the firewall as the replying service engine or reference server, and then directed to the requesting service engine, passing through the firewall via the gate-keeping message broker if necessary.

An event (i.e., a data object representing relevant activity) can be generated in several ways. First, a TLCL system user can interactively initiate an event by entering the data via the web portal. Second, a TLCL system user can use a local information system 109 or 117 to generate an event that is then passed to the external message broker 111. Finally, a service engine that is operating on an existing event can generate data that serves as the basis for further events.

In each of these cases, the event data are either generated in, or communicated to, the application server 125. Events passed to the external message broker are communicated through the firewall to the internal message broker, and then on directly to the process server via a data-type communications link. Event data generated within a service engine, be it internal or external, are communicated to the service engine communication layer 127, which then communicates the event to the process server. The data-type communications link between the service engines and the service engine communication layer can optionally be the same communications link used for interactive communication (as depicted in FIG. 1), or a different link.

Once the application server receives the event data, it directs the processing of the event through various service engines, as appropriate. The application server selects the appropriate service engines based upon the source of the data, the type of event that the data represents (e.g., a financial invoice, a status update on a shipment or a notification received from a particular country's customs service) and/or the content of the data (e.g., the exporting and importing countries, the nationalities and/or identities of the buyer and seller, the classification and type of goods, the value of the goods and the toxic or environmental relevance of the goods). In the subsequent processing of the event, additional events and queries can be generated.

The information sources 129, which are typically governmental or private entities outside the firewall 123, are also linked in communication with the external message broker 111 via connections configured for communicating data objects (denoted as being for data transfer by a “D” in FIG. 1). In some cases, they can generate events such as update notifications, sending those events to the application server via the external and internal message brokers. Additionally, service engines and/or reference servers can query the information sources for information.

The application server 125 and service engine communication layer 127 provide authentication and security for verification of each service engine's usage rights in the TLCL system with relation to a given event. In particular, the application server, which governs the operation of the service engines, controls the selection of service engines that receive an event. The service engine communication layer then polices the events passed from one service engine to another in comport with the dictates of the application server.

TLCL System Functionality

A user of the TLCL system, such as a Customer 101, a Service Activity Provider 113, or the TLCL System Provider, can access the functionality of the TLCL System by contacting the web portal 105 via a web browser over the Internet 107, an intranet, or another network connection. The user's interactive communications to the TLCL system are preferably configured for World Wide Web-based protocols, such as are used by systems operating in HTML (Hypertext Markup Language), XML (Extensible Markup Language), XSL (Extensible Stylesheet Language), Java, JSP (JavaServer Pages) and Epicentric.

As described above, the user's communications are passed via the web browser 105 through the firewall 123, and are screened for various levels of access rights by the firewall 123, the web portal 105 and the application server 125.

The application server 125, typically developed in an appropriate middleware such as bluestone products or Enterprise Java Beans, is preferably configured to seamlessly guide a user through the processes that are relevant to them. In particular, it is configured to guide a Customer 101 through import/export related processes, to guide a Service Activity Provider 113 through their relevant import/export related activities, and to guide any user through any authorized reporting, auditing, and/or accounting procedures. Preferably, after the user selects the activity that the user requires, the application server both guides the user into and through each relevant service engine, and buffers their interaction with each service engine to provide a consistent, user-friendly interface that characterized by a consistent look and feel, consistent terminology and easy-to-understand instructions. In doing so, the application server preferably accesses information on the various TLCL requirements of different countries and different users, to selectively activate the service engines (and portions of service engines) most appropriate to the user's needs.

The service engines and reference servers are configured to pass and store data such that each function is provided related data from other functions to simplify the user's experience. For example, upon the classification of goods, the application server might direct the user through a process that verified whether the goods raise legal issues regarding toxicity.

A user of the TLCL system, such as a Customer 101, a Service Activity Provider 113, or the TLCL System Provider, can also access the functionality of the TLCL System by passing data objects directly from an information system to the external message broker 111, or even to the internal message broker 161 if a separate hole is maintained in the firewall. The external and/or internal message brokers rout the data object to the application server 125, which then directs the appropriate service engines to process the event.

In their operations, the service engines might also take data and/or instruction from each other or from other software packages, typically receiving information in data-type objects. For example, when a customer first conducts a transaction, they may use local ordering processing software that generates financial-invoice-type data objects in their local information systems 109. These data objects can be transmitted via the external message broker 111 and/or internal message broker 161 to the application server, which forwards the objects to appropriate service engines, where the data is used to initiate and instruct certain processes. One such process could be the generation of a customs invoice from the financial-invoice-type data, and the transmission of the customs invoice to an appropriate broker using whatever communications technology that the broker is known to use. The process could also include selecting a broker based on past performance criteria stored in the system. Other related processes would be one to monitor the broker's performance when the broker reports its status, and add that performance data to a database of past broker performance.

The service engines will frequently include or rely upon extensive databases and lookup tables reflecting the current requirements based on the countries of shipping origin, shipping destination, and intermediary travel, as well as the countries of the Buyer's and/or Sellers citizenship. Included among these are various national and international rules and regulations, import and/or export licensing requirements, duty rates, classification codes, and other customs limitations, such as for toxic substances, packing materials, restricted parties and countries, auditing requirements, and the like.

The many governments of the world have a variety of such TLCL requirements in the form of import laws, regulations, rules, best practices and the like to deal with these subjects. These TLCL requirements change frequently. Whether it is a governmental agency or a private information service, the Information Source offers access to up-to-date information to computer systems, providing compilations of this information and/or frequently updated lists of TLCL requirement changes. These Information Sources can also be provided within components of the information systems operated by Customers, Application Service Providers and/or Service Activity Providers.

For the service engines, the external message broker 111 could serve as a gateway for updating the database information on a periodic and/or selected basis. For the internal service engines 131 and 133, the internal message broker 161 is also part of that gateway. Thus, at periodic intervals, at the instruction of the TLCL System Provider, upon receiving an update notification from an information source, or possibly at the request of a user, the service engine and the information source interact to updates the data contained in the service engine. The internal and external service engines can alternatively be updated through other forms of communication. This is particularly true for service engines that are not owned, operated or directed by the TLCL System Provider.

Service Engines

The application management system is preferably configured to work with a plurality of internal service engines 131 and 133 and a plurality of external service engines 135 and 137. Each service engine is configured to provide one or more services relating to one or more TLCL issues that arise in international import and/or export business transactions. Most service engines are configured either to run autonomously or to interact with a limited set of other service engines and/or information servers to accomplish a limited task or set of tasks.

Some service engines may be designed and written by (or under the direction of) the TLCL System Provider. Such service engines are generally operated within the firewall by employees or contractors of the TLCL System Provider. Other service engines might be applications written and owned by outside software developers, but that are significantly altered and/or configured to meet the functional needs and/or the connection requirements of the TLCL system. These service engines could readily be either inside or outside the firewall, most likely depending upon the party that operates the service engine.

Finally, some service engines are likely to be applications that are entirely owned and operated by outside entities. These entities could be Application Service Providers having expertise in some segment of the import/export industry, or even Customers 101 or Service Activity Providers 113 who are selling their information and expertise for additional profit. Therefore, while the external service engines 135 and 137 are depicted separately, it should be understood that they could reside in the information systems of the Customers or Service Activity Providers.

It typically is highly beneficial to use the service engines of Service Engine Operators such as Application Service Providers, Service Activity Providers and/or Customers that have significant import/export experience. These Service Engine Operators can have significant expertise in their particular services and/or localities of operation. Additionally, these Service Engine Operators might have existing business relationships, computer connections and/or information sources that are highly beneficial to the Customers. Indeed, it is unlikely that a single company will produce the best-of-breed software either for every TLCL function or in every legal jurisdiction. Included among the external service engines that might be accessed are tax calculation engines, logistics information and negotiations, goods classification engines, and repositories to track transactions.

Because different engines might be preferable depending on the exporting country, the importing country, the nationality of the buyer, the nationality of the seller, and even other issues such as the nature of the goods, there might be numerous service engines having similar functionality within the TLCL system. For example, one service engine might be used for import regulations in Europe, while another is used for import regulations in the United States. Furthermore, since service engines might include an integration of several functions, each having varying levels of desirability, it is very possible that the system will use one function out of a particular integrated service engine, while not using another (or only using the other for specific jobs). Additionally, the TLCL system could include service engines intended for use if other service engines are overloaded or suddenly unavailable. This would provide redundancy and thereby increase reliability.

In some cases, Service Engine Operators might have developed service engines tailored to their individual needs. For example, departments within large TLCL clients might have developed software service engines configured to deal with TLCL issues that relate to issues relatively specific to the client's products, to the Client's locality, or the Client's other software systems (such as accounting systems). Likewise, Service Activity Providers might have service engines that primarily meet their own processing needs based on their own internal procedures. For example, a freight carrier might have logistics software configured to estimate its own shipping costs and track shipments through various stages of transportation. Likewise, a customs broker might have customs software configured such that, given the financial invoices that are in transit with purchased goods, the brokers can print out customs invoices formatted it the manner in which that broker chooses to operate.

Service Engine Functions

The service engines can be configured to do a wide variety of functions. Some of these functions are interactive, and some relate to the use, manipulation, processing, storage, archiving, and reporting of data. The preferred embodiment preferably includes service engines configured to form five integrated, primary-function engines: a tax engine, an export engine, an import engine, a logistics engine and a payment engine. The preferred embodiment also includes service engines configured to provide customer management and reporting. Other embodiments could include additional functional engines, such as ones to assist in making legal decisions or manage financial transactions for international trade.

Tax Engine

The tax functional engine comprises one or more service engines that provide information, assist in reporting and/or assist in paying various taxes relating to transactions in jurisdictions around the world. Related databases include a database of tax rates for each tax jurisdiction, as well as any product classification information necessary to assess the correct tax rates.

Preferably, buyers and/or sellers can access the tax engine to determine the tax-cost of each potential transaction. This can be particularly important for large entities, which can ship or receive goods in any of a number of different countries. The savings resulting from selecting optimal shipping sources and destinations can be quite substantial. Such a calculation will generally need to consider the variation in other costs such as shipping, customs, and related support (e.g., brokering). These other costs are preferably available through other engines, as described below.

The tax functional engine also can serve as a repository for tax payment information. This provides both for the correct payments of transaction tax, and for the efficient reporting of transaction tax payments to the financial entities that calculate and pay regular corporate taxes.

Export Engine

The export functional engine includes service engines each having functionality to take care of export issues in one or more jurisdictions. One typically important export issue is the tracking and reporting of export transactions to meet the governmental summary reporting requirements of most countries. Also included are warnings against export limitations that various countries might have. For example, exports from the United States, and shipments by US entities (regardless of the export locations), are subject to restrictions on parties and/or countries that can receive the goods. Likewise, certain technologies and substances are restricted.

While many exports are not limited, licenses are required for exporting various goods from many countries. The export engine is preferably configured with service engines that verify a client has the proper export licences, and that act to apply for needed licenses. In any countries where such applications can be done electronically, the actions are preferably taken directly by the service engines. In other countries, the service engine preferably communicates with appropriate staff (at the Client, the TLCL System Provider, or an outside vender of such services), directing them to apply for the appropriate license. In either case, the service engine also acts or otherwise flags the export so that it is delayed until it is properly licensed.

Related databases accessed by the service engines of the export functional engine preferably include a database of the export reporting requirements of each jurisdiction, a database of the laws regarding restricted parties and countries with which to do business, a database of the licensing requirements of each jurisdiction, a database of the licenses actually held by the clients, and any product classification information necessary to assess the licenses needed for any given transaction.

The export functional engine also can serve as a repository for export information used in the re-importation of components within larger products, i.e., the export of goods by a first party to a manufacturer that will take the goods and incorporate them into products to be sold back to the first party. This activity is referred to as an assist. Various import options exist for claiming an assist, and preferably the service engines of the import functional engine can access both the export engine (or its records) and the client's customs preferences to determine what types of assist claims will be made.

Additionally, the export functional checks a repository for import information for indications that the exported goods were previously imported and that duties were previously paid. For such cases, the export engine activates service engines to arrange for drawbacks (i.e., a refund of the duties that were previously paid). In some countries this will entail a shipment-by-shipment application, while in others it will entail the entering of a database entry, along with a summary application being generated periodically.

Import Engine

The import functional engine includes service engines having functionality to take care of import issues in one or more jurisdictions. One typically important import issue is the handling of imported goods through customs, whether by the client themselves or a third party customs broker. Central to the import process is the proper description and classification of goods. Also, of high importance are the consistent description and classification of goods. These are both important for legal compliance with import laws in most jurisdictions. Additionally, duties need to be calculated, paid, tracked and reported for corporate financial considerations. Also, various formats and preferred business practices should be adhered to, depending on the jurisdiction.

To manage these issues effectively, the import functional engine preferably includes one or more service engines that generate, or assist in the generation of, customs invoices that consistently and accurately describe the products. Preferably these service engines take into account both the bast practices and the legal requirements of each country, as well as prior rulings by each country on each client's goods. The service engines also preferably account for any assists that are to be claimed during import, such as is described above with regard to the export functional engine. The service engines deliver the customs invoice information to the appropriate broker or company representative in the import jurisdiction in a timely fashion, preferably prior to the arrival of the goods to minimize the time spent in customs. Also, a service engine records the transaction such that the export engine can access the information and check for potential drawbacks.

To the extent possible, a customer can use the import functional engine to query a broker status of the import operation, and to study the history of performance by various brokers when selecting a broker to use. Alternatively, the functional service engine can select a broker based on its cost and history of performance.

Additionally, some countries include various limitations on the products and packaging that can be imported. These limitations can be trade limitations on products that have been imposed by certain governments. They can also be health, safety or environmental limitations, such as relating to dangerous substances, protected species, or pollution/recycling requirements on products and/or packaging. They can even be restricted parties or countries for trade, which was already discussed above with regard to the export engine.

The import engine is preferably configured with service engines that verify that the goods, the packaging, the trading partners and the exporting countries all are proper under the importing country's laws. In cases where significant issues arise that cannot be handled by the service engines, the system notifies specialists (at the Client, the TLCL System Provider, or an outside vender of such services) that action must be taken.

Related databases accessed by the service engines of the import functional engine preferably include a database of the acceptable product descriptions and classifications for each jurisdiction, a database of the customs rules, best practices and procedures of each jurisdiction, a database of the import restrictions and health/safety/environmental requirements of each jurisdiction, and a database of the product types of each client, along with prior rulings governing their classification in various jurisdictions. Also, a repository of import information, including duties paid, time in customs, and parties managing the customs operation, is preferably maintained. This repository is used both for various financial considerations and for the analysis of the performance of customs brokers and/or related parties.

Logistics Engine

The logistics functional engine includes service engines having functionality to manage logistics issues through various jurisdictions. Related databases accessed by the service engines of the logistics functional engine preferably include a database of freight forwarders and carriers serving various types of cargo in various markets, along with their rates and any discounts that can be had due to connections with the Buyer, the Seller, the TLCL System Provider, or other related parties or factors. Also, included can be a database of historic information on various performance factors of the carriers.

Preferably, buyers and/or sellers can access the logistics engine to determine the cost efficient course of shipping, considering the available forwarders and/or carriers, considering the various discounts that have been arranged due to business arrangements with the forwarders and/or carriers, and considering the history of on-time and safe delivery of cargo by each forwarder and/or carrier. To the extent possible based on forwarder/carrier arrangements, a customer can use the logistics functional engine to arrange shipments, and to query the forwarder/carrier for location and status information on the shipments.

The logistics functional engine also can serve as a repository for historic logistics information. This provides both for the analysis of carrier performance and the selection of preferred carriers.

Payment Engine

The payment functional engine includes service engines having functionality to manage payments (i.e., to instruct payment entities regarding payments, or to initiate electronic payments) made to outside vendors and/or governmental agencies for the various fees and services incurred in the TLCL portion of a business transaction that results in the international shipment of goods. Included among these payments can be customs brokers' fees, freight forwarders' fees, carriers' fees, other Service Activity Providers' fees (including any fees due to the TLCL System Provider), fees to related providers of information or electronic services, and duties. Related databases accessed by the service engines of the payment functional engine include any needed to identify costs related to the above types of payment. Also included can be a database of historic information on various payments actually made for various accounting purposes.

Additional Details

Additional details on some service engines of the present invention are contained in the following applications, which are being filed concurrently with the present application.

1) PCT patent application, entitled “Methods of Creating Electronic Customs Invoices”, Ser. No. ______, filed in the US Receiving Office on Oct. 1, 2001, under the attorney docket number 10012294-1, which is hereby incorporated herein by reference for all purposes.

2) PCT patent application, entitled “Order Fulfillment Architecture Having An Electronic Customs Invoice System”, Ser. No. ______, filed in the US Receiving Office on Oct. 1, 2001, under the attorney docket number 10012299-1, which is hereby incorporated herein by reference for all purposes.

3) PCT patent application, entitled “Regulatory Classification System”, Ser. No. ______, filed in the US Receiving Office on Oct. 1, 2001, under the attorney docket number 10002302-1, which is hereby incorporated herein by reference for all purposes.

4) PCT patent application, entitled “Export License Determination Server”, Ser. No. ______, filed in the US Receiving Office on Oct. 1, 2001, under the attorney docket number 10002306-1, which is hereby incorporated herein by reference for all purposes.

5) PCT patent application, entitled “Transaction Monitoring System”, Ser. No. ______, filed in the US Receiving Office on Oct. 1, 2001, under the attorney docket number 10002307-1, which is hereby incorporated herein by reference for all purposes.

These five applications add further detail and scope to preferred embodiments the present invention, and are considered an integral part thereof. They also provide examples of the interaction of service engines under the present invention. For example, the service engine that generates a customs invoice, such as from financial invoice information, makes extensive use of the Regulatory Classification System. Additionally, the transaction being handled by these two service engines would need to have export license approval, and thus the Export License Determination Server would likely operate on related messages for the transaction as well. The operation and communication of these service engines, and the other service engines with which they interact, define patentable systems and methods, and are within the anticipated scope of the invention.

Message Brokers

The internal and external message brokers, 161 and 111, respectively, work in conjunction as a gate-keeping message broker to facilitate data communications between the application server 125, service engines (both internal and external), reference servers 139, information sources 129, Service Activity Provider information systems 117, and other Customer information systems 109. When managing the data objects, the message brokers preferably provide a number of relevant functions.

First, each message broker preferably includes a variety of different interconnect technologies, at least one of which is configured to interconnect and receive data communications from each service engine, internal reference server, information source and/or information system to which that message broker will connect. The data can be in a wide variety of formats, such as a flat file record, an electronic data interchange (“EDI”) of structured data according to agreed message standards between computer systems, a spreadsheet entry, extensible markup language (“XML”) or web data. The message brokers will preferably have a standard communication format that is efficient for processing large amounts of data.

One or more message brokers also preferably include routers programmed with routing logic. The routing logic will preferably be based on the substantive data type (e.g., financial invoice data or updated governmental requirements) and the source of the data received. This allows for updating the data routing via changes to tables in the message brokers without reprogramming various service engines, information sources, and the like. Data objects received by the message brokers from some or all sources could include supplemental routing information, either to supplement internal routing logic, or to override it. Alternatively, the message brokers could be configured for all routing information to be included with each type of data object.

In addition, one or more message brokers are preferably programmed to include data editing and verification checking modules, extending them beyond the traditional roles of a message broker. Such modules would preferably include data format and/or substantive data checking information for various types of data. These modules would preferably use substantive logic based on the data type, and would verify the logical correspondence of data within a data object. Upon finding questionable or faulty data, the quality checking modules could reject the data back to its source, correct the data and/or direct the data to experts that can research and correct the issues in the data.

Because the message brokers are configured to work with a wide variety of data formats, the message brokers are preferably configured with data translation modules. These modules would provide the needed translation to place the data into each format required by each destination for the data. Given that data can be directed to a variety of destinations, it is possible that it will have to be translated into a variety of formats.

As an additional note, while the external and internal message brokers are depicted as a single entity, other configurations are within the scope of the invention. For example, two or more external message brokers could be interlinked, each having additional links to a different set of service engines, information sources, reference servers and/or information systems. Thus, competing providers of external message broker services could join forces to avoid creating redundant connections. Likewise, multiple internal message brokers could be used to connect multiple sites (or multiple levels of firewall security) associated with the TLCL System Provider.

Additional details on the message brokers and their advanced functions are contained in a US patent application entitled “Combined Message Broker”, Ser. No. ______, filed concurrently on Oct. 1, 2001, under the attorney docket number 10012320-1, which is hereby incorporated herein by reference for all purposes. Further details on the message brokers and their advanced functions are contained in a US patent application entitled “Verified Message Broker”, Ser. No. ______, filed concurrently on Oct. 1, 2001, under the attorney docket number 10012319-1, which is hereby incorporated herein by reference for all purposes.

These two applications add further detail and scope to preferred embodiments the present invention, and are considered an integral part thereof. They also provide examples of the mechanism of interaction of the service engines and other related modules, under the present invention. The operation and communication of these message brokers (with related disclosed modules), with the TLCL system, including the service engines that are incorporate by reference above, define patentable systems and methods, and are within the anticipated scope of the invention.

Other Features of the Invention

In the disclosed embodiment, an application management system, a message broker and a set of service modules are described as being within a single, global firewall. However it should be understood that the architecture of corporate networks can take many forms, with multiple layers of firewall or numerous local firewalls instead of a single, global firewall. The present system can be implemented in different forms, such as being distributed across various forms of network architecture. For example, for the purposes of this description, two network systems that are each protected from a public network by a firewall, and that are in communication through secure communications channels, are simply one network behind a firewall, as is discussed above.

While customers are described above as buyers or sellers, there are other entities that might act as customers. For example, Service Activity Providers or even Application Service Providers could become customers to provide their respective customers with the benefits of the available TLCL solutions. Indeed, such customers might find the TLCL solution to be superior to their in-house software for some purposes, and incorporate the system into their regular procedures.

It is to be understood that the invention comprises apparatus, software and methods for designing setting up, managing and operating service engines, and particularly for designing setting up, managing and operating TLCL service engines and their supporting architecture. Additionally, the invention comprises apparatus, software and methods related to using the services of TLCL service engines and their supporting architecture. In short, the above disclosed features can be combined in a wide variety of configurations and relate to a wide variety of licensees within the anticipated scope of the invention.

While particular forms of the invention have been illustrated and described, it will be apparent that various modifications can be made without departing from the spirit and scope of the invention. Thus, although the invention has been described in detail with reference only to the preferred embodiments, those having ordinary skill in the art will appreciate that various modifications can be made without departing from the scope of the invention. Accordingly, the invention is not intended to be limited by the above discussion, and is defined with reference to the following claims.

We claim:

1. A system for users having service needs, the system being configured to operate with a plurality of service engines including a plurality of internal service engines that operate within the protection of a software firewall and a plurality of external service engines that operate outside the protection of the firewall, each of the plurality of service engines being configured to provide one or more separate services, comprising:
an application server module within the firewall, being configured to selectively send data to, receive data from, and share data between the plurality of service engines such that the application server module selectively operates service engines to integrate their separate services into an integrated service meeting the service needs of the users; and
an interface module configured to provide the user with interactive access to the application server module to request the integrated service.

2. The system of claim 1, wherein one or more service engines of the plurality of service engines communicate using a first communication protocol, and wherein one or more service engines of the plurality of service engines communicate using a second communication protocol, and further comprising:
a service engine communication layer connecting the application server to each service engine of the plurality of service engines, the service engine communication layer being configured to translate communication protocols to facilitate communication between the application server module and each service engine of the plurality of service engines.

3. The system of claim 2, and further comprising a router configured to place the service engine communication layer in communication with each external service engine via a single hole in the firewall.

4. The system of claim 1, wherein the plurality of service engines include a plurality of interacting service engines that are configured to interact with other interacting service engines, each interacting service engine being either one of the plurality of internal service engines or one of the plurality of external service engines, and further comprising:
a combined message broker including an internal message broker in communication with each internal service engine that is an interacting service engine, and an external message broker in communication with each external service engine that is an interacting service engine;
wherein the internal message broker and the external message broker are in communication through the firewall; and
wherein the combined message broker is configured to place the interacting service engines in communication with each other.

5. The system of claim 4, wherein the plurality of service engines include a one or more referencing service engines that are configured to operate with one or more reference servers providing data storage and retrieval services, each referencing service engine being either one of the plurality of internal service engines or one of the plurality of external service engines, wherein:
the internal message broker in communication with each internal service engine that is a referencing service engine, and the external message broker in communication with each external service engine that is a referencing service engine;
the combined message broker is in communication with the one or more reference servers; and
the combined message broker is configured to place the referencing service engines in communication with the reference servers with which they are configured to operate.

6. The system of claim 4, wherein one or more of the interacting service engines interact with other interacting service engines that use different communication protocols, wherein:
the combined message broker is configured to translate communication protocols to facilitate the interaction between the interacting service engines.

7. The system of claim 6, wherein one or more users have user-computers configured to request services from the integrated service, wherein:
the internal message broker is in communication with the application server;
the external message broker is in communication with the user-computers of the one or more users, and
the combined message broker is configured to translate communication protocols and facilitate interaction between the user-computers and the application server such that the user-computers can request services.

8. The system of claim 7, wherein one or more service engines of the plurality of service engines communicate using a first communication protocol, and wherein one or more service engines of the plurality of service engines communicate using a second communication protocol, and further comprising:
a service engine communication layer connecting the application server to each service engine of the plurality of service engines, the service engine communication layer being configured to translate communication protocols to facilitate communication between the application server module and each service engine of the plurality of service engines.

9. The system of claim 8, and further comprising a router configured to place the service engine communication layer in communication with each external service engine via a single hole in the firewall.
